(19) United States
(12) Patent Application Publication
(10) Pub. No.: US 2010/0100443 A1
(43) Pub. Date: Apr. 22, 2010

(54) User classification apparatus, advertisement distribution apparatus, user classification method, advertisement distribution method, and program used thereby

(76) Inventors: Keiichiro Hoashi, Saitama (JP); Chihiro Ono, Saitama (JP); Yasuhiro Takishima, Saitama (JP)

Correspondence Address: EDWARDS ANGELL PALMER & DODGE LLP, P.O. BOX 55874, BOSTON, MA, 02205, US

(21) Appl. No.: 12/584,433

(22) Filed: Sep. 3, 2009

(30) Foreign Application Priority Data
Oct. 21, 2008 (JP) 2008-270912

(51) Int. Cl. G06Q 30/00; G06F 17/30

(52) U.S. Cl. 705/14.54; 707/706; 707/737; 707/E17.108

(57) ABSTRACT

It is an object to provide user classification apparatus, a user classification method, and a program used thereby, which classify users based on search log and support the analysis of customer trends, and advertisement distribution apparatus, an advertisement distribution method, and a program used thereby, which distribute advertisements based on the analysis of customer trends. The user classification apparatus is provided with a search log database, a user search log information extracting unit extracting search log information of a user, an analyzed keyword extracting unit extracting search keyword information contained in search log information, a search session dividing unit dividing the search log information of the user into a plurality of search sessions, a search session class extracting unit generating a class, a user belonging class calculation unit classifying the user into the class, and a user search log analysis result display unit displaying the classification result.

This application is based on and claims the benefit of priority from Japanese Patent Application No. 2008-270912, filed on 21 Oct. 2008, the content of which is incorporated herein by reference.

### BACKGROUND OF THE INVENTION

1. Field of the Invention

The present invention relates to user classification apparatus, a user classification method, and a program used thereby, which classify users based on search log of search keywords input into an information search engine by users through a communication line such as Internet and support the analysis of customer trends, and advertisement distribution apparatus, an advertisement distribution method, and a program used thereby, which distribute advertisements based on the analysis of customer trends.

2. Related Art

Recently, mobile phones with not only a wireless telephone function but also a communication terminal function have widely spread. These mobile phones can be connected with Internet to retrieve various kinds of information provided from a WWW (World Wide Web) server. Therefore, the users of these mobile phones can receive their desired information anytime and anywhere.

On Internet, the users typically search their desired web pages by inputting keywords.

A technique of providing users with personalized retrieval results has been proposed as a technique of searching web pages (for example, refer to the non-patent document “J. Teevan, et al.: Personalizing search via automated analysis of interests and activities, Proc. of ACM-SIGIR 2005, pp. 449-456, 2005”). According to the technique disclosed in this document, once a user input a search keyword with a plurality of meanings, the meaning of the search keyword input by the user can be deduced from any one of the plurality of meanings based on the search log of the user and the information on web pages browsed by the user, and web pages can be thus retrieved based on the deduced meaning.

In addition, a technique of distributing advertisements in accordance with the retrieval of web pages (for example, refer to Unexamined Japanese Patent Applications, First Publication Nos. 2002-169816 and 2007-208988). According to the technique disclosed in the former patent application, advertisements can be distributed in accordance with search keywords input by users. According to the technique disclosed in the latter patent application, users are classified into a plurality of classes based on search log information, and appropriate advertisements can be distributed to each of classes.

Furthermore, in recent years, an action targeting advertisement distribution service automatically selecting advertisements to be displayed on web pages based on the action history of users other than search action on the Web has become widely spread. According to this action targeting advertisement distribution service, user preference can be deduced based on access history to a web site cooperating with an advertising distribution company, and advertisements deductively matching preference can be distributed to each of users.

In the technique described in the above-mentioned non-patent document, the accuracy of the retrieval results can be improved by use of the search log can improve, but users cannot be classified, and advertisements and contents based on the classification results cannot be therefore distributed.

In the technique described in Unexamined Japanese Patent Application, First Publication No. 2002-169816, only advertisements corresponding to the search keyword itself input by a user are distributed. Therefore, when a keyword, which are highly linked to a search keyword stored in the device disclosed in this patent application but not is same as the stored search keyword, is input by a user, advertisements corresponding to the stored search keyword cannot be distributed to this user. In addition, advertisements in accordance with a user's instantaneous desire at the time that search keywords are input can be distributed, but advertisements in accordance with user preferences analogized from past search log and the like cannot be distributed.

In the technique described in Unexamined Japanese Patent Applications, First Publication No. 2007-208988, users are classified into a plurality of classes by the following process. First, the potential class group C extracted from search log information is defined by the expression (1). In the expression (1), k is an integer equal to the number of the extracted potential classes.

[Expression 1]

C={c_{—}1, c_{—}2; . . . , c_k} (1)

Next, in order to determine the potential class to which the user u belongs, the belonging probability P(u,c_i) of the user u to all potential classes contained in the potential class group C is calculated (i is an integer in the range 1≦i≦k.). Then, the potential class c_i when the belonging probability P(u,c_i) of the user u is maximized is determined as the potential class to which the user u belongs.

By the way, since the above-mentioned belonging probability P(u,c_i) of the user u is a probability value, the expression (2) is established.

[Expression 2]

ΣᵢP(u,c_{—}i)=1 (2)

Therefore, the belonging probability P(u,c_i) of the user u to each potential class falls between 0 and 1. Therefore, for users who have a plurality of preferences, it can be theoretically assumed that the belonging probabilities to the respective potential classes corresponding to each preference are similar.

However, when the belonging probability P(u,c_i) of the user u is calculated by the above-mentioned method, the belonging probability to one potential class becomes close to 1, and the belonging probability to other potential classes becomes extremely small value, regardless of search log information of the user u. Therefore, users who have a plurality of preferences belong to only potential classes highly linked to preferences including characteristic search keywords among a plurality of preferences.

As a result, as a problem from the viewpoint of advertisers and content providers, targets (users) likely to respond to their advertisements cannot be extracted, whereby chances to attract potential users may be lost. In addition, as a problem from the viewpoint of users, distributed advertisements and content information may be tendentious, and users may have less opportunity for receiving profitable advertisements and contents.

Furthermore, in the above-mentioned action targeting advertisement distribution service, correlating the browsing history of web sites with advertisements requires human hand. Therefore, as the size of the browsing history of web sites and the number of advertisements increase, correlating the browsing history of web sites with advertisements becomes a difficult process, and may not be carried out practically.

### SUMMARY OF THE INVENTION

It is an object of the present invention to provide user classification apparatus, a user classification method, and a program used thereby, which classify users based on search log and support the analysis of customer trends, and advertisement distribution apparatus, an advertisement distribution method, and a program used thereby, which distribute advertisements based on the analysis of customer trends.

According to a first aspect of the present invention, the user classification apparatus includes: a search keyword information extracting unit (for example, corresponding to an analyzed keyword extracting unit 103 in FIG. 1) of extracting search keyword information contained in search log information of each user who has used an information search engine (for example, corresponding to an information search engine 5 in FIG. 1); a search log information dividing unit (for example, corresponding to a search session division unit 104 in FIG. 1) of dividing search log information of a user into a plurality of search sessions, based on the search keyword information extracted by the search keyword information extracting unit and retrieval time information on a time when the search keyword information is retrieved by use of the information search engine; a class generation unit (for example, corresponding to a search session class extracting unit 105 in FIG. 1) of generating a class showing a trend of a keyword input by the user based on the search session; a search log information classifying unit (for example, corresponding to a user belonging class calculation unit 106 in FIG. 1) of classifying each of the plurality of search sessions divided by the search log information dividing unit into the class generated by the class generation unit; and a user classification unit (for example, corresponding to a user belonging class calculation unit 106 in FIG. 1) of classifying the user into the class generated by the class generation unit, based on the class into which each of the plurality of search sessions are classified by the search log information classification unit; and a classification result display unit (for example, corresponding to a user search log analysis result display unit 107 in FIG. 1) displaying a classification result from the user classification unit.

According to the present invention, in the user classification apparatus, the search keyword information extracting unit extracts the search keyword information contained in search log information of each user who has used the information search engine, and the search log information dividing unit divides search log information of a user into a plurality of search sessions based on the search keyword information extracted by the search keyword information extracting unit and retrieval time information on a time when this search keyword information is retrieved by use of the information search engine. Then, the class generation unit generates a class showing the trend of a keyword input by the user based on the search sessions, the search log information classification unit classifies each of the plurality of search sessions divided by the search log information dividing unit into the class generated by the class generation unit, the user classification unit classifies the user into the class generated by the class generation unit based on the class into which each of the plurality of search sessions is classified by the search log information classification unit, and the classification result display unit displays a classification result from the user classification unit.

Therefore, the user classification apparatus can classify users based on the search log using the information search engine, thereby supporting customer trend analysis.

According to a second aspect of the present invention, in the user classification apparatus according to the first aspect of the present invention, the search log information dividing unit divides the search log information of the user into a plurality of search sessions, and classifies one or more pieces of search keyword information in which the difference between the times of retrieval using the information search engine is equal to or less than a predetermined time into the same search session.

According to the present invention, in the user classification apparatus, the search log information dividing unit divides the search log information of the user into a plurality of search sessions. Then, the search log information dividing unit classifies one or more pieces of search keyword information in which the difference between the times of retrieval using the information search engine is equal to or less than a predetermined time, which are first search keyword information retrieved by use of the information search engine, and one or more pieces of second search keyword information retrieved during the predetermined time after this first search keyword information is retrieved, into the same search session.

Therefore, the user classification apparatus can classify users based on the times of retrieval using the information search engine, thereby supporting customer trend analysis.

According to a third aspect of the present invention, the user classification apparatus according to the second aspect of the present invention further includes a search frequency calculation unit calculating search frequency of each user based on the difference between the times of retrieval using the information search engine, in which the search log information dividing unit determines the predetermined time for each user in accordance with the search frequency calculated by the search frequency calculation unit.

According to the present invention, in the user classification apparatus, the search frequency calculation unit calculates the search frequency of each user based on the difference between the times of retrieval using the information search engine, which is the time interval between consecutive retrievals by the used information search engine. Then, the search log information dividing unit determines the above-mentioned predetermined time for each user to be used to classify the search keyword information, in accordance with the search frequency calculated by the search frequency calculation unit.

Therefore, the user classification apparatus can classify users based on the times and frequency of retrieval using the information search engine, thereby supporting customer trend analysis.

According to a fourth aspect of the present invention, the advertisement distribution apparatus includes, a search keyword information extracting unit (for example, corresponding to an analyzed search keyword extracting unit 103 in FIG. 6) of extracting search keyword information contained in search log information of each user who has used an information search engine (for example, corresponding to an information search engine 5 in FIG. 6); a search log information dividing unit (for example, corresponding to a search session division unit 104 in FIG. 6) of dividing search log information of a user into a plurality of search sessions, based on the search keyword information extracted by the search keyword information extracting unit and retrieval time information on a time when the search keyword information is retrieved by use of the information search engine; a class generation unit (for example, corresponding to a search session class extracting unit 105 in FIG. 6) of generating a class showing a trend of a keyword input by the user based on the search session; a search log information classifying unit (for example, corresponding to a user belonging class calculation unit 106 in FIG. 6) of classifying each of the plurality of search sessions divided by the search log information dividing unit into the class generated by the class generation unit; a user classification unit (for example, corresponding to a user belonging class calculation unit 106 in FIG. 6) of classifying the user into the class generated by the class generation unit, based on the class into which each of the plurality of search sessions are classified by the search log information classification unit; a distributed advertisement determination unit (for example, corresponding to a distributed advertisement determination unit 201 of FIG. 6) of determining a class into which a user to whom an advertisement is to be distributed is classified, based on a classification result from the user classification unit; and an advertisement distribution unit (for example, corresponding to an advertisement distribution unit 203 in FIG. 6) of distributing the advertisement to a user classified into the class determined by the distributed advertisement determination unit.

According to the present invention, in the advertisement distribution apparatus, the search keyword information extracting unit extracts the search keyword information contained in search log information of each user who has used the information search engine, and the search log information dividing unit divides search log information of a user into a plurality of search sessions based on the search keyword information extracted by the search keyword information extracting unit and retrieval time information on a time when the search keyword information is retrieved by use of the information search engine. Then, the class generation unit generates a class showing the trend of a keyword input by the user based on the search sessions, the search log information classification unit classifies each of the plurality of search sessions divided by the search log information dividing unit into the class generated by the class generation unit, and the user classification unit classifies the user into the class generated by the class generation unit based on the class into which each of the plurality of search sessions is classified by the search log information classification unit. In addition, the distributed advertisement determination unit determines a class into which a user to whom an advertisement is to be distributed is classified, based on a classification result from the user classification unit, and the advertisement distribution unit distributes the advertisement to a user classified into the class determined by the distributed advertisement determination unit.

Therefore, the advertisement distribution apparatus can classify users based on the search log using the information search engine, thereby supporting customer trend analysis, and distribute advertisements based on the result of customer trend analysis.

Therefore, advertisements highly linked to other search keywords input by a user can be distributed to this user. In addition, not only advertisements in accordance with a user's instantaneous desire at the time that a search keyword is input but also those in accordance with user preferences analogized from the past search log and the like can be distributed.

Furthermore, since users with a plurality of preferences can be appropriately classified into a plurality of classes, users likely to respond to their advertisements can be extracted, thereby preventing the loss of chances to attract potential users, from the viewpoint of advertisers. In addition, from the viewpoint of users, the advertisement distribution apparatus can prevent distributed advertisement information from becoming tendentious, and prevent users from having less opportunity for receiving profitable advertisements.

Moreover, correlating the browsing history of the web site with advertisements does not require human hand, so that users can be appropriately classified, and the browsing history of the web site can be correlated with advertisements even if an enormous amount of search log information is diverged.

According to a fifth aspect of the present invention, in the advertisement distribution apparatus according to the fourth aspect of the present invention, the search log information dividing unit divides the search log information of the user into a plurality of search sessions, and classifies one or more pieces of search keyword information in which the difference between the times of retrieval using the information search engine is equal to or less than a predetermined time into the same search session.

According to the present invention, in the advertisement distribution apparatus, the search log information dividing unit divides the search log information of the user into a plurality of search sessions. Then, the search log information classifies one or more pieces of search keyword information in which the difference between the times of retrieval using the information search engine is equal to or less than a predetermined time, which are first search keyword information retrieved by use of the information search engine, and one or more pieces of second search keyword information retrieved during the predetermined time after this first search keyword information is retrieved, into the same search session.

Therefore, the advertisement distribution apparatus can classify users based on the time of retrieval using the information search engine, thereby supporting customer trend analysis, and distribute advertisements based on the result of customer trend analysis.

According to a sixth aspect of the present invention, the advertisement distribution apparatus according to the fifth aspect of the present invention further includes a search frequency calculation unit calculating search frequency of each user based on the difference between the times of retrieval using the information search engine, in which the search log information dividing unit determines the predetermined time for each user in accordance with the search frequency calculated by the search frequency calculation unit.

According to the present invention, in the advertisement distribution apparatus, the search frequency calculation unit calculates the search frequency of each user based on the difference between the times of retrieval using the information search engine, which is the time interval between consecutive retrievals by the used information search engine. Then, the search log information dividing unit determines the above-mentioned predetermined time to be used to classify the search keyword, in accordance with the search frequency calculated by the search frequency calculation unit.

Therefore, the advertisement distribution apparatus can classify users based on the time and the frequency of retrieval using the information search engine, thereby supporting customer trend analysis, and distribute advertisements based on the result of customer trend analysis.

According to a seventh aspect of the present invention, the user classification method includes: a first step (for example, corresponding to a step S1 in FIG. 3) of extracting search keyword information contained in search log information of each user who has used an information search engine (for example, corresponding to an information search engine 5 in FIG. 1); a second step (for example, corresponding to a step S3 in FIG. 3) of dividing search log information of a user into a plurality of search sessions, based on the search keyword information extracted in the first step and retrieval time information on a time when the search keyword information is retrieved by use of the information search engine; a third step (for example, corresponding to a step S5 in FIG. 3) of generating a class showing a trend of a keyword input by the user based on the search session; a fourth step (for example, corresponding to a step S12 in FIG. 4) of classifying each of the plurality of search sessions divided in the second step into the class generated in the third step; a fifth step (for example, corresponding to a step S14 in FIG. 4) of classifying the user into the class generated in the third step, based on the class into which each of the plurality of search sessions is classified in the fourth step; and a sixth step (for example, corresponding to a step S8 in FIG. 3) of displaying the classification result of the fifth step.

According to the present invention, the present invention extracts the search keyword information contained in search log information of each user who has used the information search engine, and divides search log information of a user into a plurality of search sessions based on the search keyword information extracted by the search keyword information extracting unit and retrieval time information on a time when the search keyword information is retrieved by use of the information search engine. Then, the present invention generates a class showing the trend of keywords input by users based on the search session, classifies each of a plurality of divided search session into the generated class, classifies users into the class generated based on the classified class, and displays the classification result.

Therefore, the present invention can classify users based on the search log using the information search engine, thereby supporting customer trend analysis.

According to an eighth aspect of the present invention, the advertisement distribution method includes: a first step (for example, corresponding to a step S21 in FIG. 7) of extracting search keyword information contained in search log information of each user who has used an information search engine (for example, corresponding to an information search engine 5 in FIG. 6); a second step (for example, corresponding to a step S23 in FIG. 7) of dividing search log information of a user into a plurality of search sessions, based on the search keyword information extracted in the first step and retrieval time information on a time when the search keyword information is retrieved by use of the information search engine; a third step (for example, corresponding to a step S25 in FIG. 7) of generating a class showing a trend of a keyword input by the user based on the search session; a fourth step (for example, corresponding to a step S12 in FIG. 4) of classifying each of the plurality of search sessions divided in the second step into the class generated in the third step; a fifth step (for example, corresponding to a step S14 in FIG. 4) of classifying the user into the class generated in the third step, based on the class into which each of the plurality of search sessions is classified in the fourth step; a sixth step (for example, corresponding to a step S28 in FIG. 7) of determining a class into which a user to whom an advertisement is to be distributed is classified, based on the classification result of the fifth step; and a seventh step (for example, corresponding to a step S29 in FIG. 7) of distributing the advertisement to a user classified into the class determined in the sixth step.

The present invention extracts the search keyword information contained in search log information of each user who has used the information search engine, and divides search log information of a user into a plurality of search sessions based on the search keyword information extracted by the search keyword information extracting unit and retrieval time information on a time when the search keyword information is retrieved by use of the information search engine. Then, the present invention generates a class showing the trend of keywords input by users based on the search session, classifies each of a plurality of divided search session into the generated class, and classifies users into the class generated based on the classified class. In addition, the present invention determines a class into which a user to whom an advertisement is to be distributed is classified, based on a classification result from the user classification unit, and distributes the advertisement to a user classified into the determined class.

Therefore, the present invention can classify users based on the search log using the information search engine, thereby supporting customer trend analysis, and distribute advertisements based on the result of customer trend analysis.

Therefore, when a keyword, which is highly linked to a search keyword stored in the device disclosed in this patent application but not is same as the stored search keyword, is input by a user, advertisements corresponding to the stored search keyword can be distributed to this user. In addition, not only advertisements in accordance with a user's instantaneous desire at the time that a search keyword is input distributed but also those in accordance with user preferences analogized from the past search log and the like can be distributed.

Furthermore, since users with a plurality of preferences can be appropriately classified into a plurality of classes, users likely to respond to their advertisements can be extracted, thereby preventing the loss of chances to attract potential users, from the viewpoint of advertisers. In addition, from the viewpoint of users, the present invention can prevent distributed advertisement information from becoming tendentious, and prevent users from having less opportunity for receiving profitable advertisements.

Moreover, correlating the browsing history of the web site with advertisements does not require human hand, so that users can be appropriately classified, and the browsing history of the web site can be correlated with advertisements even if an enormous amount of search log information is diverged.

According to a ninth aspect of the present invention, a computer-readable medium storing a program executing a method in a computer, the method includes: a first step (for example, corresponding to a step S1 in FIG. 3) of extracting search keyword information contained in search log information of each user who has used an information search engine (for example, corresponding to an information search engine 5 in FIG. 1); a second step (for example, corresponding to a step S3 in FIG. 3) of dividing search log information of a user into a plurality of search sessions, based on the search keyword information extracted in the first step and retrieval time information on a time when the search keyword information is retrieved by use of the information search engine; a third step (for example, corresponding to a step S5 in FIG. 3) of generating a class showing a trend of a keyword input by the user based on the search session; a fourth step (for example, corresponding to a step S12 in FIG. 4) of classifying each of the plurality of search sessions divided in the second step into the class generated in the third step; a fifth step (for example, corresponding to a step S14 in FIG. 4) of classifying the user into the class generated in the third step, based on the class into which each of the plurality of search sessions is classified in the fourth step; and a sixth step (for example, corresponding to a step S8 in FIG. 3) of displaying the classification result of the fifth step.

According to the present invention, the program stored in a computer-readable medium is executed to extract the search keyword information contained in search log information of each user who has used the information search engine; divide search log information of a user into a plurality of search sessions based on the search keyword information extracted by the search keyword information extracting unit and retrieval time information on a time when the search keyword information is retrieved by use of the information search engine; generate a class showing the trend of keywords input by users based on the search session; classify each of a plurality of divided search session into the generated class; classify users into the class generated based on the classified class; and then display the classification result.

Therefore, the above-mentioned program can classify users based on the search log using the information search engine, thereby supporting customer trend analysis.

According to a tenth aspect of the present invention, a computer-readable medium storing a program executing a method in a computer, the method includes: a first step (for example, corresponding to a step S21 in FIG. 7) of extracting search keyword information contained in search log information of each user who has used an information search engine (for example, corresponding to an information search engine 5 in FIG. 6); a second step (for example, corresponding to a step S23 in FIG. 7) of dividing search log information of a user into a plurality of search sessions, based on the search keyword information extracted in the first step and retrieval time information on a time when the search keyword information is retrieved by use of the information search engine; a third step (for example, corresponding to a step S25 in FIG. 7) of generating a class showing a trend of a keyword input by the user based on the search session; a fourth step (for example, corresponding to a step S12 in FIG. 4) of classifying each of the plurality of search sessions divided in the second step into the class generated in the third step; a fifth step (for example, corresponding to a step S14 in FIG. 4) of classifying the user into the class generated in the third step, based on the class into which each of the plurality of search sessions is classified in the fourth step; a sixth step (for example, corresponding to a step S28 in FIG. 7) of determining a class into which a user to whom an advertisement is to be distributed is classified, based on the classification result of the fifth step; and a seventh step (for example, corresponding to a step S29 in FIG. 7) of distributing the advertisement to a user classified into the class determined in the sixth step.

According to the present invention, the program stored in a computer-readable medium is executed to extract the search keyword information contained in search log information of each user who has used the information search engine; divide search log information of a user into a plurality of search sessions based on the search keyword information extracted by the search keyword information extracting unit and retrieval time information on a time when the search keyword information is retrieved by use of the information search engine; generate a class showing the trend of keywords input by users based on the search session; classify each of a plurality of divided search session into the generated class; and then classify users into the class generated based on the classified class. In addition, the above-mentioned program determines a class into which a user to whom an advertisement is to be distributed is classified, based on a classification result from the user classification unit, and distributes the advertisement to a user classified into the determined class.

Therefore, the above-mentioned program can classify users based on the search log using the information search engine, thereby supporting customer trend analysis, and distribute advertisements based on the result of customer trend analysis.

Therefore, advertisements highly linked to other search keyword input by a user can be distributed to this user. In addition, not only advertisements in accordance with a user's instantaneous desire at the time that a search keyword is input distributed but also those in accordance with user preferences analogized from the past search log and the like can be distributed.

Furthermore, since users with a plurality of preferences can be appropriately classified into a plurality of classes, users likely to respond to their advertisements can be extracted, thereby preventing the loss of chances to attract potential users, from the viewpoint of advertisers. In addition, from the viewpoint of users, the above-mentioned program can prevent distributed advertisement information from becoming tendentious, and prevent users from having less opportunity for receiving profitable advertisements.

Moreover, correlating the browsing history of the web site with advertisements does not require human hand, so that users can be appropriately classified, and can the browsing history of the web site can be correlated with advertisements even if an enormous amount of search log information is diverged.

The present invention can classify users based on the search log using the information search engine, thereby supporting customer trend analysis, and distribute advertisements based on the result of customer trend analysis.

### BRIEF DESCRIPTION OF THE DRAWINGS

FIG. 1 is a diagram illustrating the structure of the user classification apparatus according to the first embodiment of the present invention;

FIG. 2 is a diagram to explain a retrieval log input from the information search engine to the user classification apparatus according to the first embodiment of the present invention;

FIG. 3 is a diagram to explain a main process performed by the user classification apparatus according to the first embodiment of the present invention;

FIG. 4 is a diagram to explain a user belonging class calculation process performed by the user classification apparatus according to the first embodiment of the present invention;

FIG. 5 is a diagram illustrating resulting search sessions divided by the user classification apparatus according to the first embodiment of the present invention;

FIG. 6 is a diagram illustrating the structure of the advertisement distribution device according to the second embodiment of the present invention; and

FIG. 7 is a diagram to explain a main process performed by the advertisement distribution device according to the second embodiment of the present invention.

### DETAILED DESCRIPTION OF THE INVENTION

Hereinafter, embodiment(s) of the present invention will be described in detail with reference to the accompanying drawing(s).

### First Embodiment

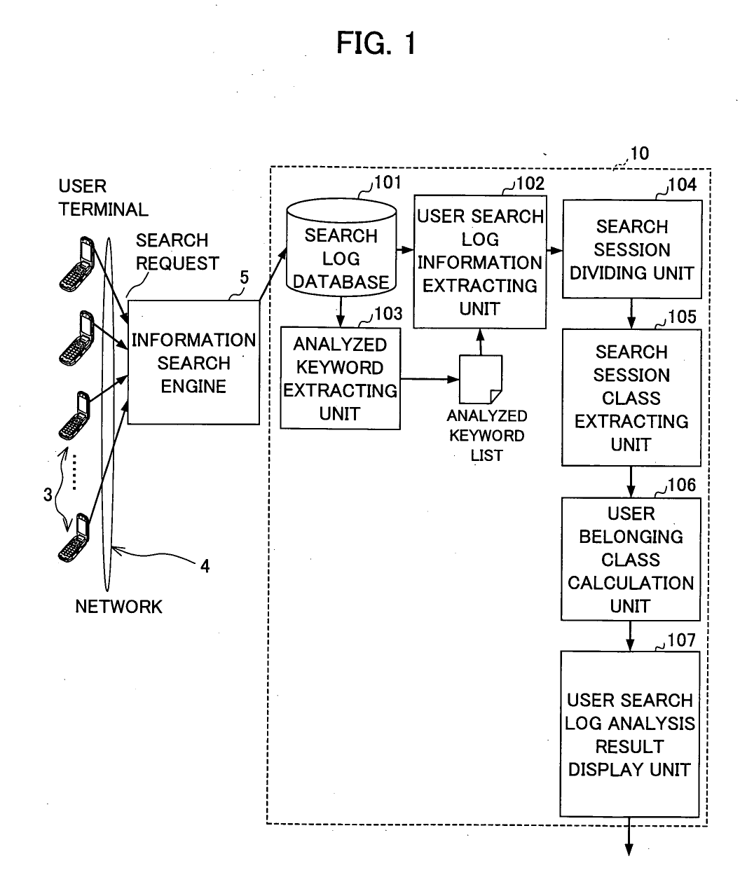

The first embodiment of the present invention will be explained with reference to FIGS. 1-5.

### Structure of User Classification Apparatus

FIG. 1 is a diagram illustrating the structure of the user classification apparatus 10 according to the first embodiment of the present invention. The user classification apparatus 10 is provided with a search log database 101 storing search logs, a user search log information extracting unit 102 collecting search log information of users, an analyzed keyword extracting unit 103 extracting search keyword information contained in search log information of each user, a search session dividing unit 104 dividing the search log information of the user into a plurality of search sessions, a search session class extracting unit 105 generating a class showing a trend of an keyword input by a user, a user belonging class calculation unit 106 classifying the user into the class generated by the search session class extracting unit 105, and a user search log analysis result display unit 107 displaying a classification result from the user belonging class calculation unit 106.

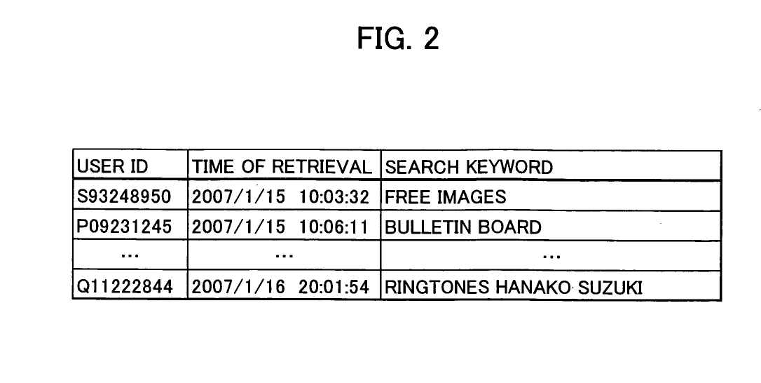

The search log database 101 collects search logs input by an information search engine 5 and stores it. Search keyword input from a user terminal 3 is input into the information search engine 5 through a network 4 and retrieved. In the present embodiment, the search log input from the information search engine 5 includes “user ID” information to identify users, “search keyword” information input by users, and “retrieval time” information which is a time when the search keyword is retrieved by the information search engine 5, as FIG. 2 shows.

The user search log information extracting unit 102 collects search log information of each user who has used the information search engine 5, and converts it into data format processable by the search session dividing unit 104.

The analyzed keyword extracting unit 103 extracts the useful pieces of search keyword information for user classification from pieces of search keyword information contained in the search log of each user who has used the information search engine 5. Specifically, the analyzed keyword extracting unit 103 calculates the occurrence rate of each piece of search keyword information contained in the search log of a user to be analyzed who has used the information search engine 5, to extract the top M pieces of search keyword information (M is an integer in the range M≧1) from pieces of search keyword information with a high occurrence rate as keyword information to be analyzed.

The search session dividing unit 104 divides search log information of a user into the plurality of search sessions based on search keyword information collected by the user search log information extracting unit 102 and retrieval time information in relation to this search keyword information. Specifically, the search session dividing unit 104 classifies one or more pieces of the search keyword information in which the difference between the times of retrieval is equal to or less than a predetermined time into the same search session.

The search session class extracting unit 105 generates a class showing the trend of the keyword input by the user based on the search session. Specifically, the search session class extracting unit 105 generates the class so that search sessions including search keyword information resembling to each other are correlated with the same class.

The user belonging class calculation unit 106 classifies the user into the class generated by the search session class extracting unit 105 based on the class to which the search session belongs, and calculates the belonging probability of the user to the class.

The user search log analysis result display unit 107 displays a classification result from the user belonging class calculation unit 106. Specifically, the user search log analysis result display unit 107 sends the information on the classification result by the user belonging class calculation unit 106 to an analysis terminal (not shown) communicatably connected with the user classification apparatus 10. Therefore, a person in charge who analyzes user history can recognize the classification result of each user from the user classification apparatus 10 by using the analysis terminal.

### User Classification Process by User Classification Apparatus

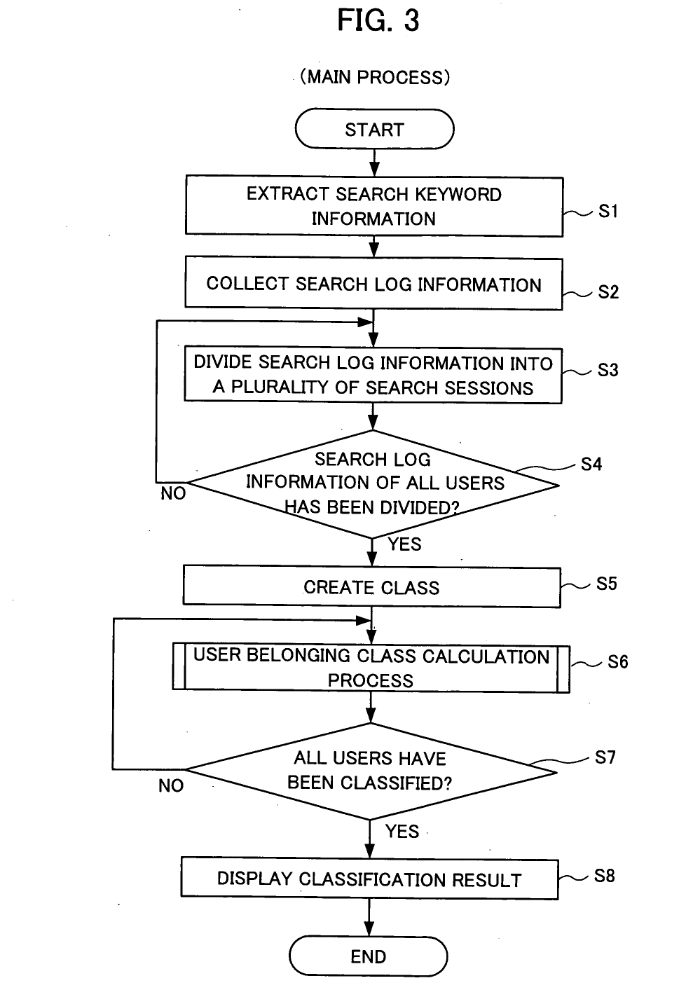

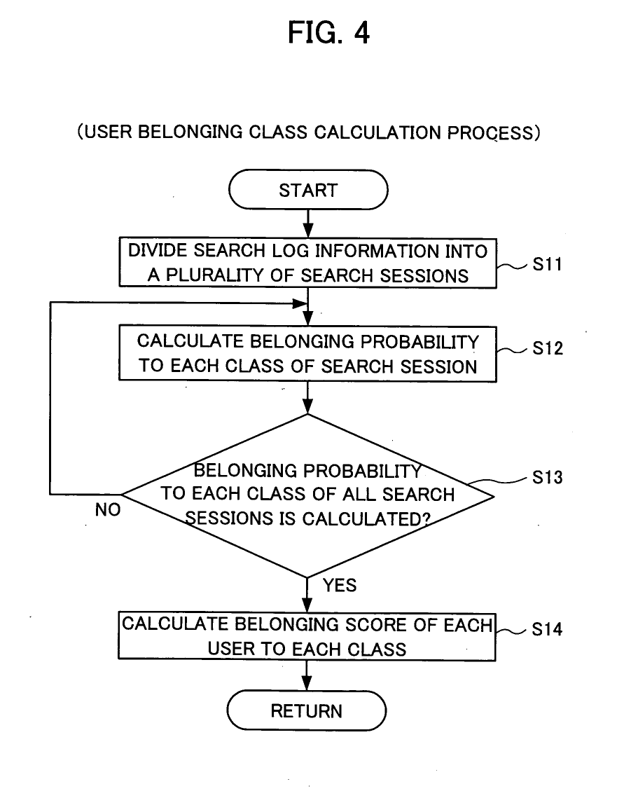

The steps of classifying users by the user classification apparatus 10 will be explained with reference to FIGS. 3 and 4.

First, the main process performed by the user classification apparatus 10 will be explained with reference to FIG. 3.

In the step S1, the analyzed keyword extracting unit 103 extracts the most useful search keyword information for user classification from pieces of search keyword information contained in the search log input by the information search engine 5.

In the step S2, the user search log information extracting unit 102 collects search log information of each user who has used the information search engine 5 to convert it into data format processable in the below-mentioned step S3. According to this process, search log information of each user is collected.

In the step S3, the search session dividing unit 104 divides search log information of a user into the plurality of search sessions based on search keyword information collected in the step S2 and retrieval time information in relation to this search keyword information.

In the step S4, the search session dividing unit 104 determines whether or not search log information of all users has been divided into a plurality of search sessions. If it is determined that search log information of all users has been divided, the process proceeds to the step S5. If it is determined that search log information of all users has not been divided yet, the process returns to the step S3.

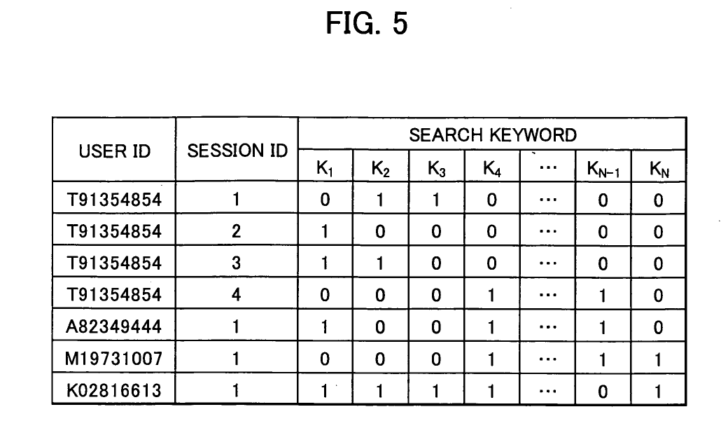

FIG. 5 is a diagram illustrating the divided search sessions when it is determined that search log information of all users have been divided in the step S4. In FIG. 5, search log information of a user with the user ID “T91354854” is divided into four search sessions. Thus, for the user with the user ID “T91354854”, the search session with the session ID “1” includes the search keywords {K2, K3}, the search session with the session ID “2” includes the search keyword {K1}, the search session with the session ID “3” includes the search keywords {K1, K2}, and the search session with the session ID “4” includes the search keywords {K4, KN-1} (N is an integer in the range N≧6).

Returning to FIG. 3, in the step S5, the search session class extracting unit 105 generates the class so that search sessions including resemble search keyword information to each other among the plurality of search sessions divided in the step S3 are correlated with the same class. In this process, a potential class can be extracted from retrieval time information by the “potential class extraction” technique proposed in “A. P. Dempster, N. M. Laird, D. B. Rubin: Maximum likelihood from incomplete data via the EM algorithm, Journal of Royal Statistic Society, Series B39, pp. 1-38, 1976”. In addition, in this process, the class can be extracted by another process such as K-means clustering.

In the step S6, the user belonging class calculation unit 106 performs the user belonging class calculation process as described hereinafter in detail with reference to FIG. 4

In the step S7, the user belonging class calculation unit 106 determines whether or not the user belonging class calculation unit 106 has performed the user belonging class calculation process to all users. If the user belonging class calculation unit 106 determines that the user belonging class calculation process has been performed to all users, the process proceeds to the step S8. If the user belonging class calculation unit 106 determines that the user belonging class calculation process has not been performed to all users, the process returns to the step S6.

In the step S8, the user search log analysis result display unit 107 sends information on the classification result of the step S6, specifically, the belonging score to each class of a user to be analyzed to the above-mentioned analysis terminal. At this point, the main process performed by the user classification apparatus 10 ends.

Next, the user belong class calculation process performed by the user classification apparatus 10 will be explained with reference to FIG. 4.

In the step S11, the user belonging class calculation unit 106 divides search log information of a user to be analyzed into the plurality of search sessions. In this process, search log information of a user to be analyzed is divided into the plurality of search sessions by a method similar to the method of dividing search log information of a user into the plurality of search sessions divided in the step S3. When search log information of a user to be analyzed has already been divided into the plurality of search sessions, this process may be omitted.

In the step S12, the user belonging class calculation unit 106 calculates the belonging probability to each class of all search sessions of a user to be analyzed. The expression (3) represents the search session group Su divided from search log information of the user u, and the expression (4) represents the generated class group C. However, in the expression (3), n is an integer equal to the number of the divided search sessions. In the expression (4), k is an integer equal to the number of the generated classes.

[Expression 3]

Sᵤ={Sᵤ₁, Sᵤ₂, . . . , Sᵤₙ} (3)

[Expression 4]

C={c₁, c₂, . . . , cₖ} (4)

In process of the step S12, the belonging probability ProbClass(Sui,cj) to the class cj of the search session Sui for all search sessions of the user u to be analyzed is calculated (i is an integer in the range 1≦i≦n, and j is an integer in the range).

In the step S13, the user belonging class calculation unit 106 determines whether or not the belonging probability ProbClass(Sui,cj) to the class cj of the search session Sui for all search sessions of the user u to be analyzed has been calculated. If the user belonging class calculation unit 106 determines that the belonging probability ProbClass(Sui,cj) to the class cj of the search session Sui for all search sessions of the user u to be analyzed has been calculated, the process proceeds to the step S14. If the user belonging class calculation unit 106 determines that the belonging probability ProbClass(Sui,cj) to the class cj of the search session Sui for all search sessions of the user u to be analyzed has not been calculated, the process returns to the step S12.

In the step S14, the belonging score to each class contained in the class group C of the user u to be analyzed is calculated. Specifically, the expression (5) represents the belonging score Score(u,cj) of the user u to all the classes cj belongs to the class group C.

$$\begin{matrix}[ Expression 5 ] & \\ Score = ( u , {c}_{j} ) = {\sum }_{i = 1}^{n} ProbClass ( {S}_{ui} , {c}_{j} ) & ( 5 )\end{matrix}$$

The belonging score Score(u,cj) to each class of the user u to be analyzed, which is calculated in the step S14, is sent to the above-mentioned analysis terminal in the step S8. A person in charge who analyzes user history can determine that a class in which the belonging score Score(u,cj) sent to the analysis terminal is equal to or larger than the predetermined threshold as a class to which the user u belongs, or can use the belonging score Score(u,cj) sent to the analysis terminal as it is, thereby understanding the use trend of search by the user u and analyzing it.

The user classification apparatus 10 can classify users based on the time of retrieval using the information search engine 5, thereby supporting a person in charge who analyzes user history to conduct customer trend analysis by using the analysis terminal.

### Second Embodiment

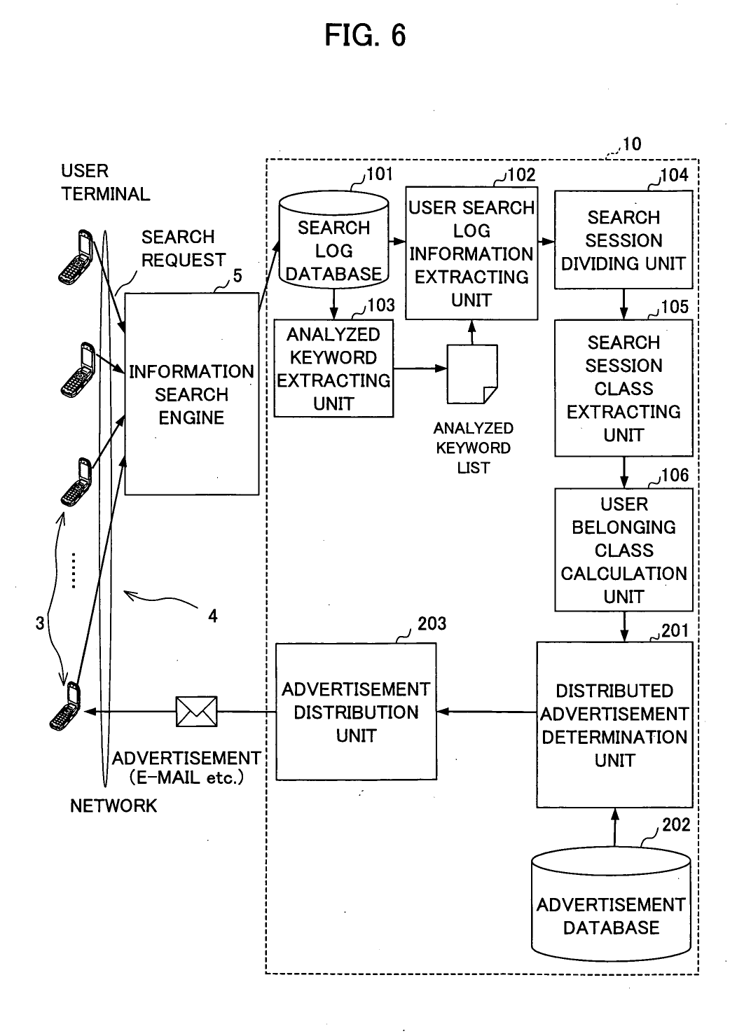

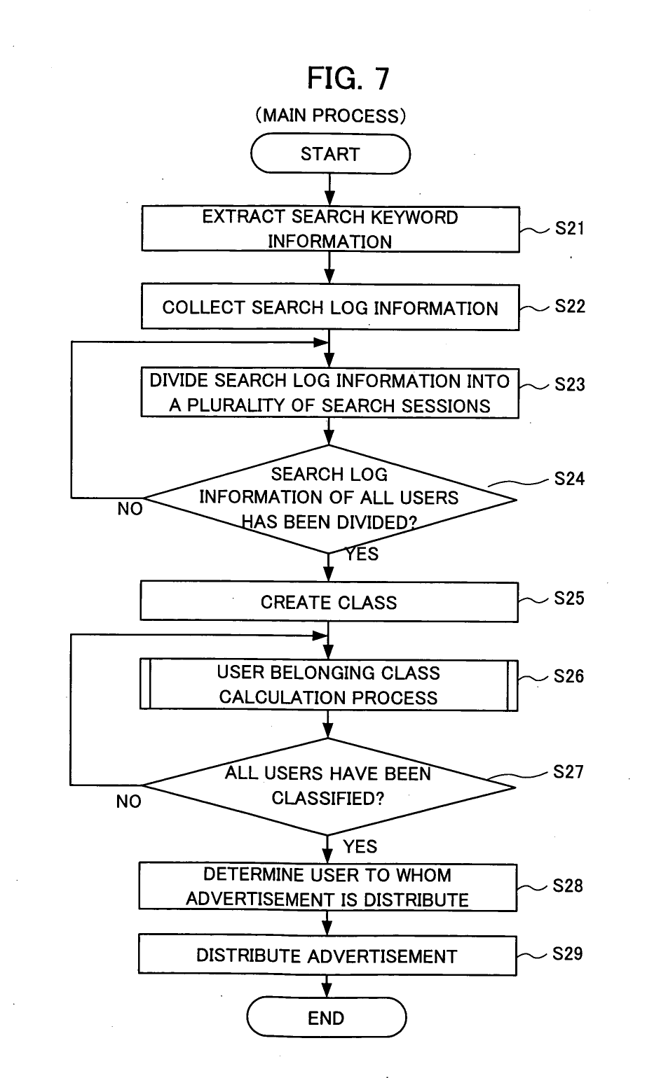

The second embodiment of the present invention will be explained with reference to FIGS. 6 and 7.

### Structure of Advertisement Distribution Apparatus

FIG. 6 is a diagram illustrating the structure of the advertisement distribution device 20 according to the second embodiment of the present invention. The advertisement distribution apparatus 20 differ from the user classification apparatus 10 according to the above-mentioned first embodiment in that the advertisement distribution apparatus 20 is provided with a distributed advertisement determination unit 201, an advertisement database 202, and an advertisement distribution unit 203 instead of the user search log analysis result display unit 107.

The advertisement database 202 stores advertisements provided from advertisers and relevant keyword information relating to the provided advertisements.

The distributed advertisement determination unit 201 determines a class into which a user to whom advertisements are distributed is classified, based on a classification result from a user belonging class calculation unit 106 and relevant keyword information stored in the advertisement database 202. Specifically, the distributed advertisement determination unit 201 receives information of the class into which a user to be analyzed is classified and search keyword information input by a user classified into each class from the user belonging class calculation unit 106. Then, for example, the distributed advertisement determination unit 201 counts the number of times in which the same search keyword information as relevant keyword information is input by a user, and determines the class with the most number of times as a class into which a user to whom an advertisement is to be distributed is classified. When text information is included in an advertisement, this text information may be extracted as relevant keyword information, and the class into which a user to whom an advertisement is to be distributed is classified may be determined, based on the extracted relevant keyword information.

The advertisement distribution unit 203 distributes advertisements to a user classified into a class determined by the distributed advertisement determination unit 201, by e-mail.

### Advertisement Distribution Process by Advertisement Distribution Apparatus

The steps of distributing advertisements to users by the advertisement distribution apparatus 20 will be explained with reference to FIG. 7.

The processes of the steps S21-S27 are performed in similar ways to those of the steps S1-S7 explained in the above-mentioned first embodiment, respectively. In the step S26, the similar processes to those of the steps S11-S14 explained in the first above-mentioned embodiment are performed.

In the step S28, the distributed advertisement determination unit 201 determines a class into which a user to whom an advertisement is to be distributed is classified, based on the classification result of the step S26 and relevant keyword information stored in the advertisement database 202.

In the step S29, the advertisement distribution unit 203 distributes the advertisement to a user classified into the class determined in the step S28.

The above-mentioned advertisement distribution apparatus 20 can classify users based on search log using the information search engine 5, thereby supporting customer trend analysis, and can distribute advertisements based on the result of customer trend analysis.

Therefore, advertisements highly linked to other search keyword input by a user can be distributed to this user. In addition, not only advertisements in accordance with a users' instantaneous desire at the time that a search keyword is input distributed but also those in accordance with user preferences analogized from the past search log and the like can be distributed.

Furthermore, users with a plurality of preferences can be appropriately classified into a plurality of classes. Thus, from the viewpoint of advertisers, users likely to respond to advertisements from advertisers can be extracted, whereby the loss of chances to attract potential users can be prevented. In addition, from the viewpoint of users, the above-mentioned advertisement distribution apparatus 20 can prevent distributed advertisement information from becoming tendentious, and prevent users from having less opportunity for receiving profitable advertisements.

Moreover, correlating the browsing history of the web site with advertisements does not require human hand, so that users can be appropriately classified, and the browsing history of the web site can be correlated with advertisements even if an enormous amount of search log information is diverged.

The processes performed by the above-mentioned user classification apparatus 10 and the above-mentioned advertisement distribution apparatus 20 are recorded on a computer-readable storage medium, read out by the user classification apparatus 10 and the advertisement distribution apparatus 20 composing a computer system, and performed, whereby the present invention can be achieved. The computer system herein includes OS (Operation System) and hardware such as, peripheral devices.

The “computer system” includes homepage providing environment (or displaying environment) when the WWW (World Wide Web) system is used. The above-mentioned program is transmitted from a computer system in which this program is stored on a memory device and the like to other computer systems through the transmission medium or a transmitted wave in a transmission medium, or. The “transmission medium” transmitting a program herein is a medium with a function transmitting information, for example, a network (communication network) such as Internet and communication links (communication lines) such as telephone lines.

The above-mentioned program may fulfill a part of the above-mentioned function. In addition, the above-mentioned program may fulfill the above-mentioned function by combining another program already stored in the computer system, which is a so-called differential file (program).

Hereinbefore, the embodiments of the present invention have been explained in detail with reference to the drawings. However, the specific structure is not limited to these embodiments, and includes design and the like within the scope of the present invention.

For example, in the above-mentioned first embodiment, the user classification apparatus 10 classifies one or more pieces of the search keyword information in which the difference between the times of retrieval is equal to or less than a predetermined time into the same search session. However, the user classification apparatus 10 may set this predetermined time for each user. Specifically, the user classification apparatus 10 may calculate the average value of the interval between times of retrieval by the information search engine 5, and set the predetermined time based on the calculated average value.

In the above-mentioned second embodiment, the advertisement distribution apparatus 20 distributes advertisements, but is not limited thereto. Various contents may be distributed.

In addition, in the above-mentioned second embodiment, the advertisement distribution unit 203 distributes advertisements by e-mail, but is not limited thereto. For example, the advertisement distribution unit 203 may display advertisements on a web site which users access, for example, so-called banner advertisements.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. User classification apparatus comprising:
a search keyword information extracting unit extracting search keyword information contained in search log information of each user who has used an information search engine;
a search log information dividing unit dividing search log information of a user into a plurality of search sessions, based on the search keyword information extracted by the search keyword information extracting unit and retrieval time information on a time when the search keyword information is retrieved by use of the information search engine;
a class generation unit generating a class showing a trend of a keyword input by the user based on the search session;
a search log information classifying unit classifying each of the plurality of search sessions divided by the search log information dividing unit into the class generated by the class generation unit;
a user classification unit classifying the user into the class generated by the class generation unit, based on the class into which each of the plurality of search sessions are classified by the search log information classification unit; and
a classification result display unit displaying a classification result from the user classification unit.

2. The user classification apparatus according to claim 1, wherein the search log information dividing unit divides the search log information of the user into a plurality of search sessions, and classifies one or more pieces of search keyword information in which the difference between the times of retrieval using the information search engine is equal to or less than a predetermined time into the same search session.

3. The user classification apparatus according to claim 2, further comprising a search frequency calculation unit calculating search frequency of each user based on the difference between the times of retrieval using the information search engine, wherein the search log information dividing unit determines the predetermined time for each user in accordance with the search frequency calculated by the search frequency calculation unit.

4. Advertisement distribution apparatus comprising:
a search keyword information extracting unit extracting search keyword information contained in search log information of each user who has used an information search engine;
a search log information dividing unit dividing search log information of a user into a plurality of search sessions, based on the search keyword information extracted by the search keyword information extracting unit and retrieval time information on a time when the search keyword information is retrieved by use of the information search engine;
a class generation unit generating a class showing a trend of a keyword input by the user based on the search session;
a search log information classifying unit classifying each of the plurality of search sessions divided by the search log information dividing unit into the class generated by the class generation unit;
a user classification unit classifying the user into the class generated by the class generation unit, based on the class into which each of the plurality of search sessions are classified by the search log information classification unit;
a distributed advertisement determination unit determining a class into which a user to whom an advertisement is to be distributed is classified, based on a classification result from the user classification unit; and
an advertisement distribution unit distributing the advertisement to a user classified into the class determined by the distributed advertisement determination unit.

5. The advertisement distribution apparatus according to claim 4, wherein the search log information dividing unit divides the search log information of the user into a plurality of search sessions, and classifies one or more pieces of search keyword information in which the difference between the times of retrieval using the information search engine is equal to or less than a predetermined time into the same search session.

6. The advertisement distribution apparatus according to claim 5, further comprising a search frequency calculation unit calculating search frequency of each user based on the difference between the times of retrieval using the information search engine, wherein the search log information dividing unit determines the predetermined time for each user in accordance with the search frequency calculated by the search frequency calculation unit.

7. A user classification method comprising:
a first step of extracting search keyword information contained in search log information of each user who has used an information search engine;
a second step of dividing search log information of a user into a plurality of search sessions, based on the search keyword information extracted in the first step and retrieval time information on a time when the search keyword information is retrieved by use of the information search engine;
a third step of generating a class showing a trend of a keyword input by the user based on the search session;
a fourth step of classifying each of the plurality of search sessions divided in the second step into the class generated in the third step;
a fifth step of classifying the user into the class generated in the third step, based on the class into which each of the plurality of search sessions is classified in the fourth step; and
a sixth step of displaying the classification result of the fifth step.

8. An advertisement distribution method comprising:
a first step of extracting search keyword information contained in search log information of each user who has used an information search engine;
a second step of dividing search log information of a user into a plurality of search sessions, based on the search keyword information extracted in the first step and retrieval time information on a time when the search keyword information is retrieved by use of the information search engine;
a third step of generating a class showing a trend of a keyword input by the user based on the search session;
a fourth step of classifying each of the plurality of search sessions divided in the second step into the class generated in the third step;
a fifth step of classifying the user into the class generated in the third step, based on the class into which each of the plurality of search sessions is classified in the fourth step;
a sixth step of determining a class into which a user to whom an advertisement is to be distributed is classified, based on the classification result of the fifth step; and
a seventh step of distributing the advertisement to a user classified into the class determined in the sixth step.

9. A computer-readable medium storing a program executing a method in a computer, the method comprising:
a first step of extracting search keyword information contained in search log information of each user who has used an information search engine;
a second step of dividing search log information of a user into a plurality of search sessions, based on the search keyword information extracted in the first step and retrieval time information on a time when the search keyword information is retrieved by use of the information search engine;
a third step of generating a class showing a trend of a keyword input by the user based on the search session;
a fourth step of classifying each of the plurality of search sessions divided in the second step into the class generated in the third step;
a fifth step of classifying the user into the class generated in the third step, based on the class into which each of the plurality of search sessions is classified in the fourth step; and
a sixth step of displaying the classification result of the fifth step.

10. A computer-readable medium storing a program executing a method in a computer, the method comprising:
a first step of extracting search keyword information contained in search log information of each user who has used an information search engine;
a second step of dividing search log information of a user into a plurality of search sessions, based on the search keyword information extracted in the first step and retrieval time information on a time when the search keyword information is retrieved by use of the information search engine;
a third step of generating a class showing a trend of a keyword input by the user based on the search session;
a fourth step of classifying each of the plurality of search sessions divided in the second step into the class generated in the third step;
a fifth step of classifying the user into the class generated in the third step, based on the class into which each of the plurality of search sessions is classified in the fourth step;
a sixth step of determining a class into which a user to whom an advertisement is to be distributed is classified, based on the classification result of the fifth step; and
a seventh step of distributing the advertisement to a user classified into the class determined in the sixth step.
